(19) United States
(12) Patent Application Publication
(10) Pub. No.: US 2026/0330753 A1
(43) Pub. Date: Oct. 22, 2026

(54) SYSTEM AND METHOD FOR ESTIMATING A LIGHT MAP OF A REAL-WORLD SCENE

(71) Applicant: Samsung Electronics Co., Ltd., Suwon-si (KR)

(72) Inventors: Raghavan VELAPPAN, Bengaluru (IN); Saransh Dhiren DAVE, Bengaluru (IN)

(21) Appl. No.: 19/468,337

(22) Filed: Feb. 3, 2026

Related U.S. Application Data
(63) Continuation of application No. PCT/KR2025/022054, filed on Dec. 17, 2025.

(30) Foreign Application Priority Data
Feb. 3, 2025 (IN) 202541008876

(51) Int. Cl. G06T 15/50

(52) U.S. Cl. CPC G06T 15/506; G06T 2210/21

(57) ABSTRACT

A method for estimating a light map of real-world scene is provided. The method includes receiving a plurality of images corresponding to the real-world scene by a plurality of cameras, generating a 3-dimensional (3D) representation of the real-world scene based on the received plurality of images, positioning a virtual sphere within the generated 3D representation of the real-world scene, estimating a coarse light map of the real-world scene on the virtual sphere, generating at least one 2-dimensional (2D) image corresponding to the virtual sphere with the estimated coarse light map estimating an enhanced virtual sphere by operating the at least one generated 2D image based on a pre-trained diffusion model, and estimating the light map of the real-world scene based on the enhanced virtual sphere.

### CROSS-REFERENCE TO RELATED APPLICATION(S)

This application is a continuation application, claiming priority under 35 U.S.C. § 365(c), of an International application No. PCT/KR2025/022054, filed on Dec. 17, 2025, which is based on and claims the benefit of an Indian patent application number 202541008876, filed on Feb. 3, 2025, in the Indian Intellectual Property Office, the disclosure of which is incorporated by reference herein in its entirety.

### TECHNICAL FIELD

The disclosure relates to a field of augmented reality/mixed reality (AR/MR). More particularly, the disclosure relates to a system and a method for estimating a light map of a real-world scene.

### BACKGROUND ART

Mixed Reality/Augmented Reality (MR/AR) are emerging technologies that blur the lines between the physical and the digital world and are currently being used in various fields, for example, the medical field, the gaming field, etc. In AR, virtual objects and/or annotations, such as a piece of information are overlaid onto the physical environment, altering the perception of a user. Further, in the MR, both the physical environment and the digital world are combined in a shared environment, where the best of virtual reality (VR) and AR are blended to create an interactive experience for the user. Further, as the virtual objects and the information are overlaid onto the physical environment, thus, a more immersive and engaging experience is created for the user. When the virtual objects are overlaid onto the physical environment, a photo-realistic effect, for example, re-lighting of the virtual objects, caused by the physical environment on the virtual objects is rendered into the AR/MR, through various means, for example, a mirror ball (physical mirror ball), as shown in FIG. 1.

FIG. 1 illustrates a scenario having a physical mirror ball for an AR/MR according to the related art.

Referring to FIG. 1, in scenario 100 the mirror ball is used as a lighting probes for re-lighting the virtual objects, when the virtual objects overlaid onto the physical environment. The mirror ball is positioned at a location where the virtual objects need to be re-lighted. Further, the environmental lighting information as captured by the mirror ball is used for generating the light map for re-lighting the virtual objects. Thereafter, the virtual objects are placed at the location where the mirror ball is positioned and thus, re-lighted with the generated light map. However, the physical setting up and positioning of the mirror ball is cumbersome. Further, the mirror ball requires continuous maintenance and is also prone to wear and tear which impacts the efficiency of the mirror ball.

Further, to overcome the above problem, there have been multiple technological advancements to increase the effectiveness of the mirror ball. In known art, a system is disclosed that estimates the appearance of the mirror ball using neural network-based models. The system considers a single scene image as an input and predicts the appearance of the mirror ball. However, the system as disclosed has limitations, that is, the system is compatible with limited scenes that correspond to similar scenes in a training data set. The result of the mirror ball as generated by the system is noisy and does not correctly predict the surrounding lighting information of the scene. Further, the system as disclosed has a possibility to generate undesired artifacts that falsely represent the lighting condition of the scene. Further, the false lighting condition of the scene generates an undesired light map that does not comply with the actual lighting information of the scene. This affects the seamless integration of the virtual objects in the physical environment, thereby compromising the experience of the user while accessing the AR/VR space.

Therefore, in view of the above-mentioned problems, it is advantageous to provide a system and a method that can overcome the issues associated with the re-lighting of the virtual objects.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide a system and a method for estimating a light map of a real-world scene.

Additional aspects will be set forth in part in the description which follows and, in part, will be apparent from the description, or may be learned by practice of the presented embodiments.

In accordance with an aspect of the disclosure, a method for estimating a light map of a real-world scene is provided. The method includes receiving a plurality of images corresponding to the real-world scene by a plurality of cameras, generating a 3-dimensional (3D) representation of the real-world scene based on the received plurality of images, positioning a virtual sphere within the generated 3D representation of the real-world scene, estimating a coarse light map of the real-world scene on the virtual sphere, generating at least one 2-dimensional (2D) image corresponding to the virtual sphere with the estimated coarse light map, estimating an enhanced virtual sphere by operating the at least one generated 2D image based on a pre-trained diffusion model, and estimating the light map of the real-world scene based on the enhanced virtual sphere.

In accordance with another aspect of the disclosure, a system for estimating a light map of a real-world scene is provided. The system includes memory, comprising one or more storage media, storing instructions, and at least one processor communicatively coupled to the memory, wherein instructions, when executed by the at least one processor individually or collectively, cause the system to receive a plurality of images corresponding to the real-world scene by a plurality of cameras, generate a 3-dimensional (3D) representation of the real-world scene based on the received plurality of images, position a virtual sphere within the generated 3D representation of the real-world scene, estimate a coarse light map of the real-world scene on the virtual sphere, generate at least one 2-dimensional (2D) image corresponding to the virtual sphere with the estimated coarse light map, estimate an enhanced virtual sphere by operating the at least one generated 2D image based on a pre-trained diffusion model, and estimate the light map of the real-world scene based on the enhanced virtual sphere.

In accordance with another aspect of the disclosure, one or more non-transitory computer-readable storage media storing one or more computer programs including computer-executable instructions that, when executed by one or more processors of a system individually or collectively, cause the system to perform operations is provided. The operations include receiving a plurality of images corresponding to the real-world scene by a plurality of cameras, generating a 3-dimensional (3D) representation of the real-world scene based on the received plurality of images, positioning a virtual sphere within the generated 3D representation of the real-world scene, estimating a coarse light map of the real-world scene on the virtual sphere, generating at least one 2-dimensional (2D) image corresponding to the virtual sphere with the estimated coarse light map, estimating an enhanced virtual sphere by operating the at least one generated 2D image based on a pre-trained diffusion model, and estimating the light map of the real-world scene based on the enhanced virtual sphere.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 illustrates a scenario having a physical mirror ball for an Augmented Reality/Mixed Reality according to the related art;

FIG. 2 illustrates an environment of a system communicably coupled with a device, according to an embodiment of the disclosure;

FIG. 3 illustrates a block diagram of the system, according to an embodiment of the disclosure;

FIG. 4 illustrates a block diagram of an operation performed by the system to estimate a light map of a real-world scene to re-light a plurality of virtual objects in the device, according to an embodiment of the disclosure;

FIG. 5 illustrates an architecture for capturing a plurality of images, according to an embodiment of the disclosure;

FIG. 6 illustrates a training of a neural radiance field (NeRF) model, according to an embodiment of the disclosure;

FIG. 7 illustrates a virtual sphere in a 3-dimensional representation of the real-world scene, according to an embodiment of the disclosure;

FIG. 8A illustrates a coarse light map of the real-world scene, according to an embodiment of the disclosure;

FIG. 8B illustrates an operation performed to generate the coarse light map, according to an embodiment of the disclosure;

FIG. 9A illustrates an enhanced virtual sphere, according to an embodiment of the disclosure;

FIG. 9B illustrates an operation performed to estimate the enhanced virtual sphere, according to an embodiment of the disclosure; and

FIG. 10 illustrates a flow chart of a method to estimate the light map of the real-world scene to re-light the plurality of virtual objects in the device, according to an embodiment of the disclosure.

Throughout the drawings, like reference numerals will be understood to refer to like parts, components, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For example, the term “some” as used herein may be understood as “none” or “one” or “more than one” or “all.” Therefore, the terms “none,” “one,” “more than one,” “more than one, but not all” or “all” would fall under the definition of “some.” It should be appreciated by a person skilled in the art that the terminology and structure employed herein is for describing, teaching, and illuminating some embodiments and their specific features and elements and therefore, should not be construed to limit, restrict, or reduce the spirit and scope of the disclosure in any way.

For example, any terms used herein, such as “includes,” “comprises,” “has,” “consists,” and similar grammatical variants do not specify an exact limitation or restriction, and certainly do not exclude the possible addition of a plurality of features or elements, unless otherwise stated. Further, such terms must not be taken to exclude the possible removal of the plurality of the listed features and elements, unless otherwise stated, for example, by using the limiting language including, but not limited to, “must comprise” or “needs to include.”

Whether or not a certain feature or element was limited to being used only once, it may still be referred to as “plurality of features” or “plurality of elements” or “at least one feature” or “at least one element.” Furthermore, the use of the terms “plurality of” or “at least one” feature or element do not preclude there being none of that feature or element, unless otherwise specified by limiting language including, but not limited to, “there needs to be plurality of . . . ” or “plurality of elements is required.”

Unless otherwise defined, all terms and especially any technical and/or scientific terms, used herein may be taken to have the same meaning as commonly understood by a person ordinarily skilled in the art.

Reference is made herein to some “embodiments.” It should be understood that an embodiment is an example of a possible implementation of any features and/or elements of the disclosure. Some embodiments have been described for the purpose of explaining plurality of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment,” “furthermore embodiment,” “additional embodiment” or other variants thereof do not necessarily refer to the same embodiments. Unless otherwise specified, plurality of particular features and/or elements described in connection with plurality of embodiments may be found in one embodiment, or may be found in more than one embodiment, or may be found in all embodiments, or may be found in no embodiments. Although plurality of features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The disclosure discloses a system and method for estimating a light map of a real-world scene to re-light a plurality of virtual objects in an extended reality in a device. The system and method use a neural radial field (NeRF) model and a diffusion model to re-light the plurality of virtual objects. The NeRF assists in capturing the surrounding information of the real-world scene and also assists in estimating the light map roughly in the form of a virtual mirror. Further, the diffusion model enhances the quality of the estimated light map. Thus, the generated output is consistent with the real surrounding/environment scene information and is also hyper realistic. The usage of the NeRF model and the diffusion model enhances relighting quality matric and reduces the storage required for capturing the information of the environment. The efficiency of the system and the method improves with continuous operation, thus, caching improves the quality of inference continuously and also provides a high quality output for the scenes which are well-known.

Embodiments of the disclosure will be described below in detail with reference to the accompanying drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

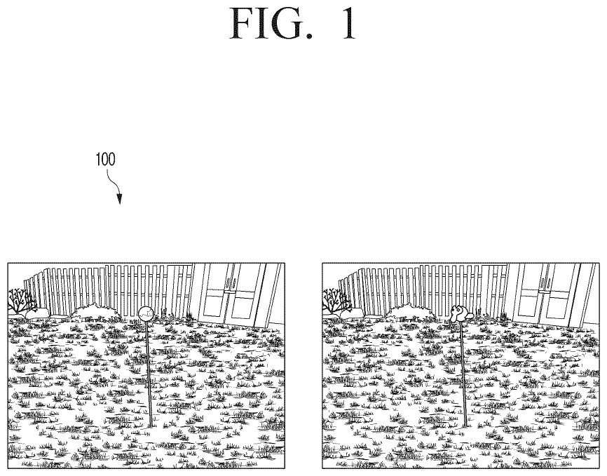

FIG. 1 illustrates a scenario having a physical mirror ball for an Augmented Reality/Mixed Reality according to the related art.

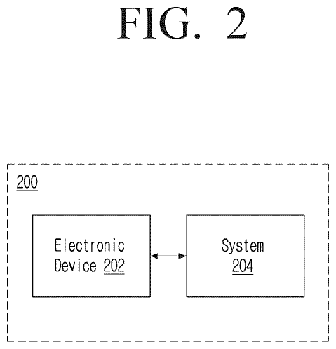

FIG. 2 illustrates an environment including a system communicably coupled with an electronic device, according to an embodiment of the disclosure.

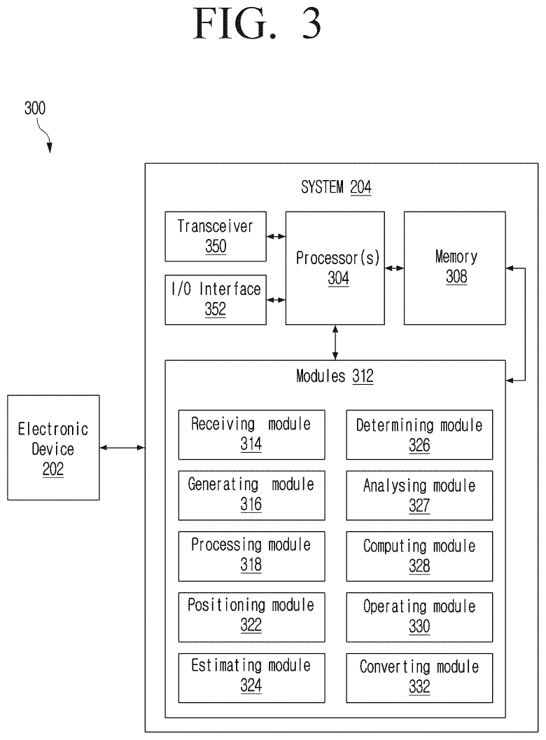

FIG. 3 illustrates a block diagram of a system in connection with the electronic device, according to an embodiment of the disclosure.

Referring to FIG. 2, an environment 200 is illustrated including a system 204 communicably coupled with an electronic device 202. The electronic device 202 (interchangeably referred to as a device 202) may be a smartphone, or any other electronic device having a camera that is known in the art, without departing from the scope of the disclosure. In an embodiment, the device 202 may be configured to support an augmented reality/mixed reality (AR/MR), where a virtual object is overlaid in a physical environment, without departing from the scope of the disclosure. Further, when the virtual object is overlaid in the physical requirement, then a photo-realistic effect, for example, re-lighting of the virtual object, caused by the physical environment on the virtual object is to be rendered into the AR/MR. Thus, the system 204 is disclosed which may be configured to estimate a light map of a real-world scene based on a plurality of inputs to render the photo realistic effect into the AR/MR. In an embodiment, the system 204 may be communicatively coupled with the device 202. In another embodiment, the system 204 may be deployed within the device 202, without departing from the scope of the disclosure. In an embodiment, the system 204 may be configured to estimate the light map of the real-world scene to re-light a plurality of virtual objects in the device 202, without departing from the scope of the disclosure.

Referring to FIG. 3, a block diagram 300 of a system 204 in connection with the electronic device 202 is illustrated. The system 204 may include, but is not limited to, at least one processor 304 (referred to here as a processor 304), memory 308, and a plurality of modules 312 among other examples which are explained in detail in subsequent paragraphs. The processor 304 may be in communication with the memory 308. Further, the system 204 may include an Input/Output (I/O) interface 352 and a transceiver 350. Further, in some embodiments where the system 204 may be implemented as a standalone entity at a server/cloud architecture, the system 204 may be in communication with multiple devices to receive data from each of the multiple devices, and the details provided below with respect to the system 204 and the device 202, are applicable for the system 204 and the multiple user devices as well.

In an embodiment, the processor 304 may be communicatively coupled with the memory 308, without departing from the scope of the disclosure. The processor 304 may be operatively coupled to each of the I/O interface 352, the plurality of modules 312, the transceiver 350, and the memory 308. In one embodiment, the processor 304 may include a graphics processing unit (GPU) and/or an artificial intelligence engine (AIE). In one embodiment, the processor 304 may include at least one data processor for executing processes in a virtual storage area network. The processor 304 may include specialized processing units such as integrated system (bus) controllers, memory management control units, floating point units, graphics processing units, digital signal processing units, etc. In one embodiment, the processor 304 may include a central processing unit (CPU), a graphics processing unit (GPU), or both. The processor 304 may be one or more general processors, digital signal processors, application-specific integrated circuits, field-programmable gate arrays, servers, networks, digital circuits, analog circuits, combinations thereof, or other now-known or later developed devices for analyzing and processing data. The processor 304 may execute a software program, such as code generated manually (i.e., programmed) to perform the desired operation.

The processor 304 may be disposed in communication with one or more input/output (I/O) devices via the I/O interface 352. In some embodiments, the processor 304 may communicate with the device 202 using the I/O interface 352. In some embodiments, the I/O interface 352 may be implemented within the device 202. The I/O interface 352 may employ communication code-division multiple access (CDMA), high-speed packet access (HSPA+), global system for mobile communications (GSM), long-term evolution (LTE), WiMax, or the like. In an embodiment, the I/O interface 352 may enable input and output to and from the system 204 using suitable devices such as, but not limited to, display, keyboard, mouse, touch screen, microphone, speaker, and so forth.

Using the I/O interface 352, the system 204 may communicate with one or more I/O devices, specifically, the device 202, to which the system 204 estimate the light map of the real-world scene to re-light the virtual objects in the device 202. For example, the input device may be an antenna, microphone, touch screen, touchpad, storage device, transceiver, video device/source, etc. The output devices may be a video display (e.g., cathode ray tube (CRT), liquid crystal display (LCD), light-emitting diode (LED), plasma, Plasma Display Panel (PDP), Organic light-emitting diode display (OLED) or the like), audio speaker, etc.

The processor 304 may be disposed in communication with a communication network via a network interface. In an embodiment, the network interface may be the I/O interface 352. The network interface may connect to the communication network to enable the connection of the system 204 with the device 202. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the system 204 may communicate with other devices. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

The transceiver 350 may be configured to receive and/or transmit signals to and from the device 202. In one embodiment, the database may be configured to store the information as required by the plurality of modules 312 and the processor 304 to perform one or more functions for estimating the light map of the real-world scene to re-light the virtual objects in the device 202.

In some embodiments, the memory 308 may be communicatively coupled to the processor 304. The memory 308 may be configured to store data, and instructions executable by the processor 304 to perform the one or more methods disclosed herein throughout the disclosure. In one embodiment, the memory 308 may be provided within the device 202. In another embodiment, the memory 308 may be provided within the system 204 being remote from the device 202. In yet another embodiment, the memory 308 may communicate with the processor 304 via a bus within the system 204. In yet another embodiment, the memory 308 may be located remote from the processor 304 and may be in communication with the processor 304 via a network. The memory 308 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like.

In one example, the memory 308 may include a cache or random-access memory for the processor 304. In alternative examples, the memory 308 is separate from the processor 304, such as a cache memory of a processor, the system memory, or other memory. The memory 308 may be an external storage device or database for storing data. The memory 308 may be operable to store instructions executable by the processor 304. The functions, acts, or tasks illustrated in the figures or described may be performed by the programmed processor 304 for executing the instructions stored in the memory 308. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

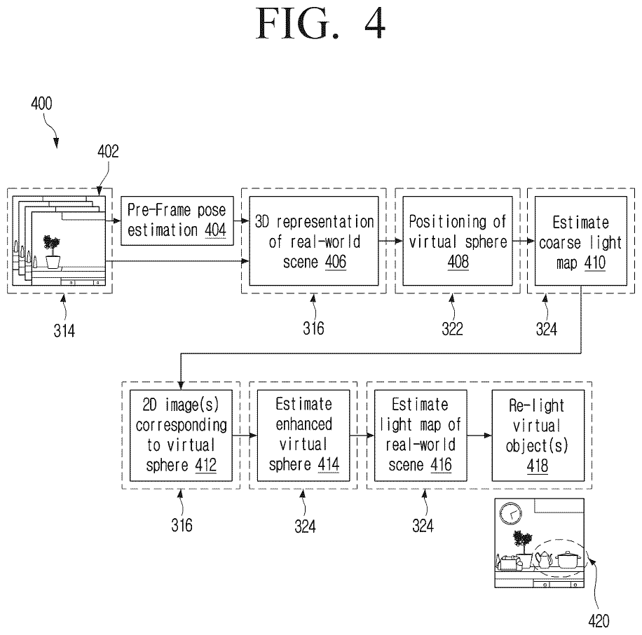

In some embodiments, the plurality of modules 312 may be included within the memory 308. The memory 308 may further include a database to store data. The plurality of modules 312 may include a set of instructions that may be executed to cause the system 204, in particular, the processor 304 of the system 204, to perform any one or more of the methods/processes disclosed herein. The plurality of modules 312 may be configured to perform the steps of the disclosure using the data stored in the database. For instance, the plurality of modules 312 may be configured to perform the steps disclosed in FIGS. 4 to 7, 8A, 8B, 9A, and 9B.

In an embodiment, each of the plurality of modules 312 may be a hardware unit that may be outside the memory 308. Further, the memory 308 may include an operating system for performing one or more tasks of the system 204, as performed by a generic operating system.

In one example, the modules 312 may include a receiving module 314, a generating module 316, a processing module 318, a positioning module 322, an estimating module 324, a determining module 326, an analysing module 327, a computing module 328, an operating module 330, and a converting module 332. Each of the module 314-332 may be in communication with each other. Further, each of the module 314-332 may be in communication with the processor 304.

Further, the disclosure contemplates a computer-readable medium that includes instructions or receives and executes instructions responsive to a propagated signal. Further, the instructions may be transmitted or received over the network via a communication port or interface or using a bus (not shown). The communication port or interface may be a part of the processor 304 or may be a separate component. The communication port may be created in software or may be a physical connection in hardware.

The communication port may be configured to connect with the network, external media, the display, or any other components in the system, or combinations thereof. The connection with the network may be a physical connection, such as a wired Ethernet connection, or may be established wirelessly. Likewise, the additional connections with other components of the system 204 may be physical or may be established wirelessly. The network may alternatively be directly connected to a bus. For the sake of brevity, the architecture and standard operations of the memory 308, the processor 304, the transceiver 350, and the I/O interface 352 are not discussed in detail.

Further, in an embodiment, the working of the system 204 to estimate the light map of the real-world scene to re-light the virtual objects in the device 202 is explained in detail. The processor 304, in conjunction with each of the module 314-332 may be configured to perform specific operations explained in later paragraphs in conjunction with FIGS. 4 to 7, 8A, 8B, 9A, and 9B.

FIG. 4 illustrates a block diagram of an operation performed by the system, according to an embodiment of the disclosure.

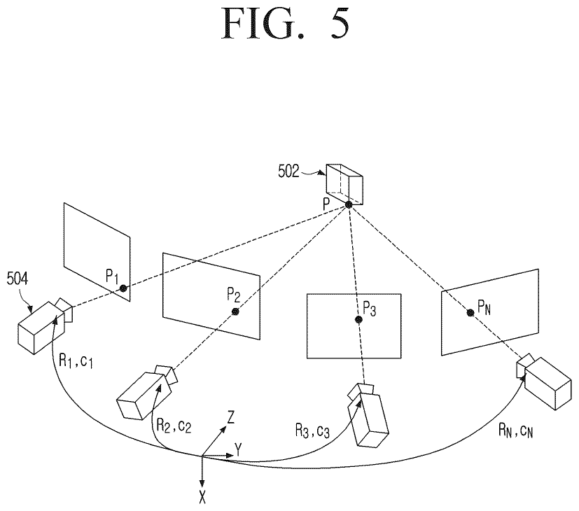

FIG. 5 illustrates an architecture for capturing a plurality of images 502, according to an embodiment of the disclosure.

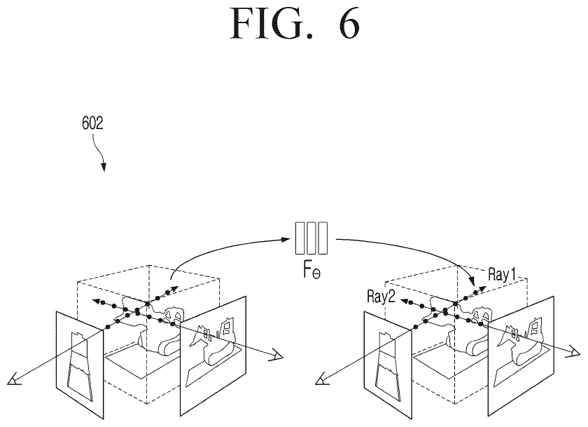

FIG. 6 illustrates a training of a neural radiance field (NeRF) model 602, according to an embodiment of the disclosure.

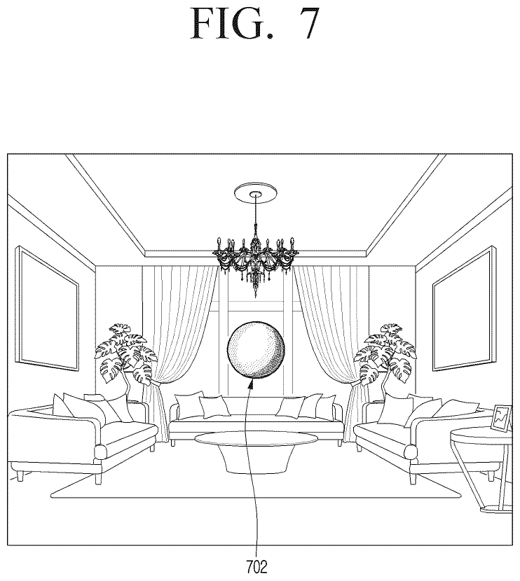

FIG. 7 illustrates a virtual sphere in a 3-dimensional representation of the real-world scene, according to an embodiment of the disclosure.

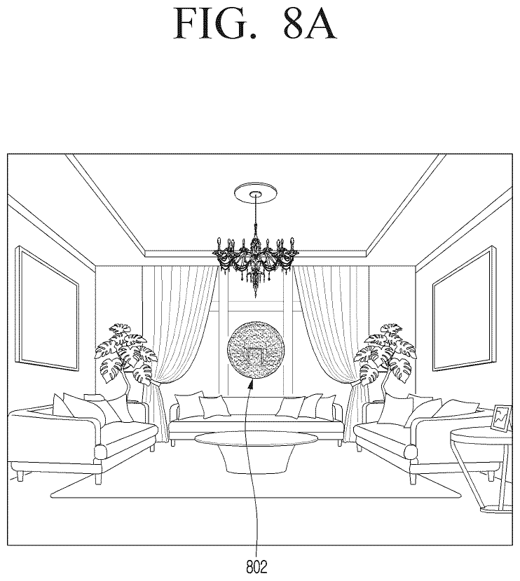

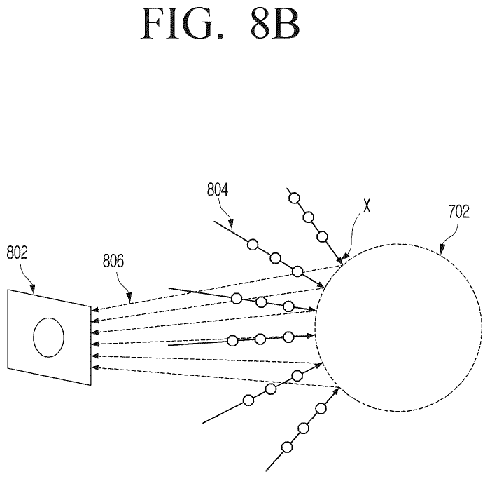

FIG. 8A illustrates a coarse light map of the real-world scene, according to an embodiment of the disclosure.

FIG. 8B illustrates an operation performed to generate the coarse light map 802, according to an embodiment of the disclosure.

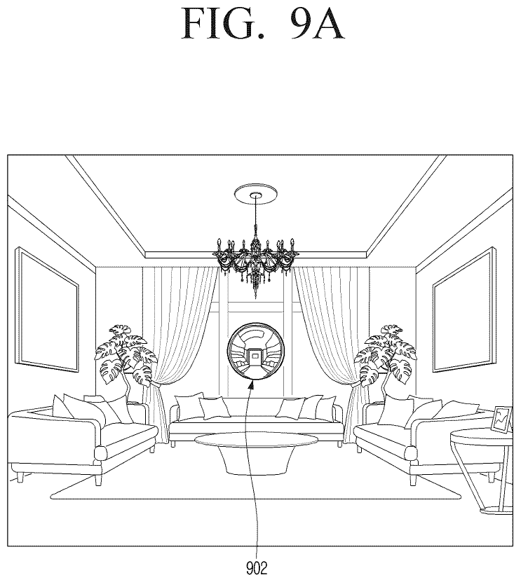

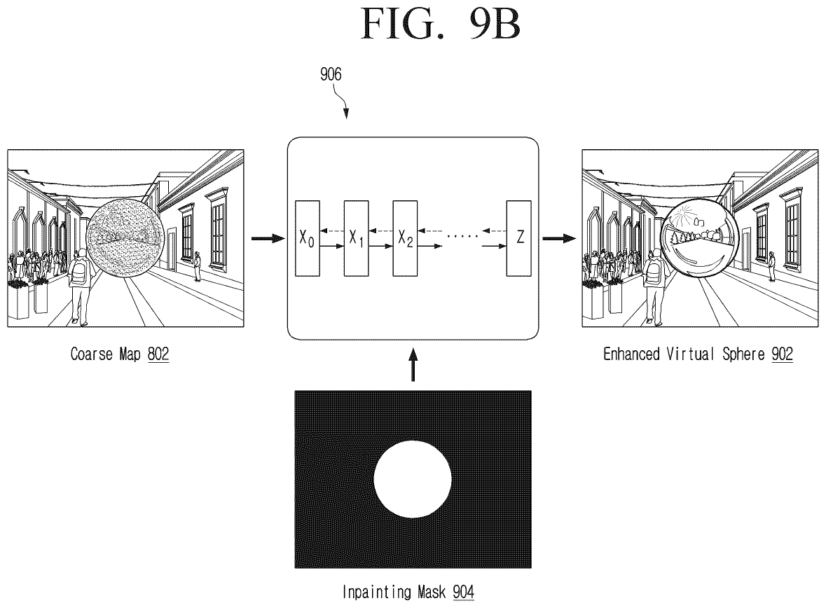

FIG. 9A illustrates an enhanced virtual sphere, according to an embodiment of the disclosure.

FIG. 9B illustrates an operation performed to estimate the enhanced virtual sphere, according to an embodiment of the disclosure.

FIGS. 4 to 7, 8A, 8B, 9A, and 9B may be explained in conjunction with each other for the sake of brevity.

Referring to FIG. 4, operation 400 may begin at block 402, where the receiving module 314 may be configured to receive the plurality of images 502 corresponding to the real-world scene by a plurality of cameras 504. In another embodiment, the receiving module 314 may be configured to receive the plurality of images 502 corresponding to the real-world scene by one or more cameras, without departing from the scope of the disclosure. Further, at block 404 and referring to FIG. 5, the plurality of images 502 may be captured in different views by each camera, thus capturing all possible information from the real-world scene. In an example, camera 1, camera 2, and . . . camera N capture the plurality of images from different views, i.e., P1, P2, P3, . . . , and PN.

Referring to FIG. 4, at block 406, the generating module 316 may be configured to generate the 3-dimensional (3D) representation of the real-world scene based on the received plurality of images 502. In an embodiment, the 3D representation is defined as a digital representation of the real-world scene that is superimposed onto a view of a user of the real-world scene.

In such an embodiment, the processing module 318 may be configured to process the received plurality of images 502 based on the neural radiance field (NeRF) model 602. Particularly, after receiving the plurality of images 502, the processing module 318 may be configured to train the NeRF model 602 based on the plurality of images 502 as shown in FIG. 6.

Referring to FIG. 6, the NeRF model 602 considers the plurality of images 502 as an input and predicts a volumetric information of the real-world scene based on the plurality of images 502. Particularly, the NeRF model 602 may use a neural network (F_theta) to predict a colour and a density of a point in 3D space. Further, multiple points may be sampled along each ray of each pixel of the plurality of images 502 to project the real-world scene from a particular view using the NeRF model 602. Further, based on the predictions of density and colour on these volumetric samples, the pixel colour may be calculated and projected for each ray to get the final view of the real-world scene.

Thereafter, the processing module 318 may be configured to process the received plurality of images 502 based on the NeRF model 602. The NeRF model 602 analyses the plurality of images 502 and uses a completely connected deep neural network, for example, multilayer perceptron, to represent the 3D form of the real-world scene. Thereafter, the generating module 316 may be configured to generate the 3D representation of the real-world scene based on the processed plurality of images 502. The operations as mentioned assist in capturing the lighting information of the real-world scene. Additionally, the operation as mentioned also assist in capturing the lighting information of unseen views of the real-world scene.

Referring to FIG. 4, at block 408 the positioning module 322 may be configured to position the virtual sphere 702, as shown in FIG. 7, within the generated 3D representation of the real-world scene. The virtual sphere 702 may be positioned at a location corresponding to a placement of at least one of the plurality of virtual objects 420 in the 3D representation of the real-world scene. In an example, a kettle (virtual object) is supposed to be placed on a table in a living room (real-world scene). In that case, the virtual sphere 702 may be placed on the table or near the table. Further, the virtual sphere is a reflective mirror ball rendered in the AR/VR environment, without departing from the scope of the disclosure.

In an embodiment, at block 410, the estimating module 324 may be configured to estimate the coarse light map 802, as shown in FIG. 8A, of the real-world scene on the virtual sphere 702. In an embodiment, the coarse light map 802 is defined as a map having a lower resolution which is used to store the lighting information associated with the real-world scene.

Referring to FIGS. 3, 4, 5, 7 and 8B, the receiving module 314 may be configured to receive a plurality of incident rays 804 from the real-world scene corresponding to the received plurality of images 502. In an embodiment, the incident ray indicates rays transmitted through pixels of a plane of the plurality of images 502 to a viewpoint selected to view the virtual sphere 702. Further, the virtual sphere 702 is positioned at the location corresponding to the placement of at least one of the plurality of virtual objects 420.

The determining module 326 may be configured to determine an intersection (denoted by X) of the plurality of incident rays 804 on the virtual sphere 702. The computing module 328 may be configured to compute the plurality of reflected rays 806 associated with the virtual sphere 702 when the plurality of incident rays 804 is intersected on the virtual sphere 702. The analysing module 327 may be configured to analyse the computed plurality of reflected rays 806 based on the NeRF model 602. The estimating module 324 may be configured to estimate the coarse light map 802 of the real-world scene on the virtual sphere 702, based on the analysed plurality of reflected rays 806. The coarse light map 802 may indicate the noisy projection of the real-world scene on the virtual sphere 702. Further, if the plurality of incident rays 804 is not intersected on the virtual sphere 702, then in that case, the estimating module 324 may be configured to estimate the coarse light map 802 of the real-world scene on the virtual sphere 702, particularly the plurality of incident rays 804, based on the NeRF model 602. The estimation of the coarse light map 802 may be determined based on following Equation 1 as the colour visible at any point of the virtual sphere 702 may be same as the colour visible along the reflected ray at that point:

∠i=∠r Equation 1

Where ∠i & ∠r are the angle of incidence and angle of reflection respectively.

In an embodiment, referring to FIG. 4, at block 412, the generating module 316 may be configured to generate at least one 2D image corresponding to the virtual sphere 702 with the estimated coarse light map 802. The at least one 2D image ensures effective information associated with the real-world scene.

In an embodiment, at block 414, the estimating module 324 may be configured to estimate the enhanced virtual sphere 902, as shown in FIG. 9A, by operating the at least one generated 2D image based on a pre-trained diffusion model 906. In an embodiment, the pre-trained diffusion model 906 is a stable diffusion. The stable diffusion may be a generative artificial intelligence model majorly created for enhancing the virtual sphere from prompts, for example, text prompt.

In such an embodiment, referring to FIGS. 3 and 9B, the operating module 330 may be configured to operate the at least one generated 2D image based on a ControlNet technique and the pre-trained diffusion model 906, by at least one of a prompt notification and an inpainting mask 904. In an embodiment, the inpainting mask 904 indicates a defined area that specifies the region where inpainting is required. The inpainting mask 904 indicates an incomplete area that needs to be filled with appropriate texture/content. The prompt notification refers to an immediate/timely notification given by the user. Further, the ControlNet technique is an assistance for fine-tuning the outputs generated by the pre-trained diffusion model 906. The ControlNet technique considers image cues, and a text prompt as an input, and provides a refined high-quality hyper-realistic image as the output in accordance with the enhancement instructions as provided in the text prompt. Lastly, the estimating module 324 may be configured to estimate the enhanced virtual sphere 902, in 2D, based on the operation. The enhanced virtual sphere 902 may indicate a hyper-realistic sphere mirror.

In an example, the ControlNet technique receives the inpainting mask 904 of the virtual sphere 702 as an image cue. Further, the ControlNet technique receives the text prompt like “Fine-tune the appearance of Mirror Ball, Hyper-realistic reflections, Remove noise.?” Thereafter, based on the inpainting mask 904 and the text prompt, the pre-trained diffusion model 906 receives an input as the at least one 2D image corresponding to the virtual sphere 702 with the estimated coarse light map 802. Further, the pre-trained diffusion model 906 along with the ControlNet technique, based on the received input, estimates the enhanced virtual sphere 902, in 2D as an output.

In an embodiment, referring to FIG. 4, at blocks 416 and 418, the estimating module 324 may be configured to estimate the light map of the real-world scene based on the enhanced virtual sphere to re-light the virtual objects 420 in the device 202.

In such an embodiment, the converting module 332 may be configured to convert the enhanced virtual sphere 902 (as shown in FIGS. 9A and 9B) from 2D to 3D enhanced virtual sphere. The determining module 326 may be configured to determine an intersection of a plurality of incident rays, passing through each enhanced virtual sphere. The determining module 326 may be configured to determine a surface normal for each of the plurality of images, based on the intersection. In an embodiment, the surface normal is defined as a vector that is perpendicular to the surface of each of the plurality of images. The computing module 328 may be configured to compute a plurality of reflected rays associated with the enhanced virtual sphere, based on the determined surface normal as the surface normal defines a manner in which the light is reflected. The estimating module 324 may be configured to estimate the light map of the real-world scene based on light intensities corresponding to the computed plurality of reflected rays to re-light the plurality of virtual objects in an extended reality in the device 202. In an example, the light map may be one of an equi-rectangular map and a cube map.

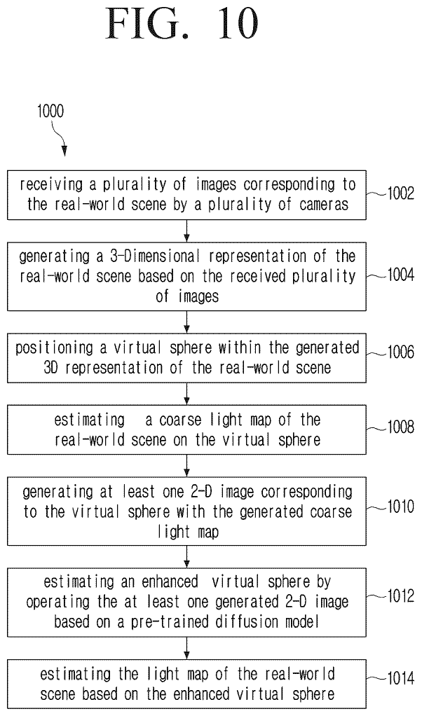

FIG. 10 illustrates a flow chart depicting a method to estimate the light map of the real-world scene, according to an embodiment of the disclosure.

A method 1000 includes a series of operations shown at operations 1002 through 1014 of FIG. 10. The method 1000 may be performed by the system 204 in conjunction with modules 312, the details of which are explained in conjunction with FIGS. 3 to 7, 8A, 8B, 9A and 9B and the same are not repeated here for the sake of brevity in the disclosure. The method 1000 begins at operation 1002.

At operation 1002, the method 1000 includes receiving the plurality of images 502 corresponding to the real-world scene by the plurality of cameras 504.

At operation 1004, the method 1000 includes generating the 3-dimensional representation of the real-world scene based on the received plurality of images 502. The method 1000 includes processing the received plurality of images 502 based on the neural radiance field (NeRF) model 602. The method 1000 includes generating the 3D representation of the real-world scene based on the processed plurality of images 502.

At operation 1006, the method 1000 includes positioning the virtual sphere 702 within the generated 3D representation of the real-world scene. The virtual sphere 702 may be positioned at the location corresponding to the placement of at least one of the plurality of virtual objects 420 in the 3-dimensional representation of the real-world scene.

At operation 1008, the method 1000 includes estimating the coarse light map 802 of the real-world scene on the virtual sphere 702. The method 1000 includes receiving the plurality of incident rays 804 from the real-world scene corresponding to the received plurality of images 502. The method 1000 includes determining the intersection of the plurality of incident rays 804 on the virtual sphere 702. The method 1000 includes computing the plurality of reflected rays 806 associated with the virtual sphere 702, when the plurality of incident rays 804 may be intersected on the virtual sphere 702. The method 1000 includes analysing the computed plurality of reflected rays 806 based on the neural radiance field (NeRF) model 602. The method 1000 includes estimating the coarse light map 802 of the real-world scene on the virtual sphere 702, based on the analysed plurality of reflected rays 806. The coarse light map 802 may indicate the noisy projection of the real-world scene on the virtual sphere 702.

At operation 1010, the method 1000 includes generating the at least one 2D image corresponding to the virtual sphere 702 with the estimated coarse light map 802.

At operation 1012, the method 1000 includes estimating the enhanced virtual sphere 902 by operating the at least one generated 2D image based on the pre-trained diffusion model 906. The method 1000 includes operating the at least one generated 2D image based on the ControlNet technique and the pre-trained diffusion model 906, by at least one of the prompt notification and the inpainting mask 904. The method 1000 includes estimating the enhanced virtual sphere 902, in 2D, based on the operation. The enhanced virtual sphere 902 indicates a hyper-realistic sphere mirror.

At operation 1014, the method 1000 includes estimating the light map of the real-world scene based on the enhanced virtual sphere 902. The method 1000 includes converting the enhanced virtual sphere 902 from 2D to 3D enhanced virtual sphere. The method 1000 includes determining the intersection of the plurality of incident rays, passing through each enhanced virtual sphere. The method 1000 includes determining the surface normal for each of the plurality of images, based on the intersection. The method 1000 includes computing the plurality of reflected rays associated with the enhanced virtual sphere, based on the determined surface normal. The method 1000 includes estimating the light map of the real-world scene based on light intensities corresponding to the computed plurality of reflected rays to re-light the plurality of virtual objects 420 in the extended reality.

As would be gathered, the system 204 and the method 1000 as disclosed estimate the light map of the real-time scene to re-light the plurality of virtual objects in the extended reality. This re-lighting of the plurality of virtual objects enhanced realism and this ensures a better visual experience for the user. The system 204 and the method 1000 virtually estimate the appearance of a mirror ball known as the virtual sphere 702 while eliminating the requirement of physically setting up and positioning the mirror ball unlike the existing art, thus, ensuring the comfort of a user. The system 204 and the method 1000 use the NeRF model to generate the coarse map 802, based on which the pre-trained diffusion model 906 estimates the enhanced virtual sphere 902. The use of NeRF model and the pre-trained diffusion model 906 ensures that the pre-trained diffusion model 906 estimates the enhanced virtual sphere 902 instead of providing any false information. Thus, the system 204 and the method 1000, based on the NeRF model and the pre-trained diffusion model 906 accurately provide the lighting information of the real-world scene and generate high quality, hyper-realistic plurality of virtual objects.

The system 204 and the method 1000 as disclosed may be used for virtual Try-on applications or other applications, for example, virtual interior design. Herein, the user may virtually experience the appearance of the object, when the object is actually tried on or placed somewhere.

In this application, unless specifically stated otherwise, the use of the singular includes the plural and the use of “or” means “and/or.” Furthermore, use of the terms “including” or “having” is not limiting. Any range described herein will be understood to include the endpoints and all values between the endpoints. Features of the disclosed embodiments may be combined, rearranged, omitted, etc., within the scope of the disclosure to produce additional embodiments. Furthermore, certain features may sometimes be used to advantage without a corresponding use of other features.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for estimating a light map of a real-world scene, the method comprising:
receiving a plurality of images corresponding to the real-world scene by a plurality of cameras;
generating a 3-dimensional (3D) representation of the real-world scene based on the received plurality of images;
positioning a virtual sphere within the generated 3D representation of the real-world scene;
estimating a coarse light map of the real-world scene on the virtual sphere;
generating at least one 2-dimensional (2D) image corresponding to the virtual sphere with the estimated coarse light map;
estimating an enhanced virtual sphere by operating the at least one generated 2D image based on a pre-trained diffusion model; and
estimating the light map of the real-world scene based on the enhanced virtual sphere.

2. The method as claimed in claim 1, wherein the generating of the 3D representation of the real-world scene comprises:
processing the received plurality of images based on a neural radiance field (NeRF) model; and
generating the 3D representation of the real-world scene based on the processed plurality of images.

3. The method as claimed in claim 1, wherein the virtual sphere is positioned at a location corresponding to a placement of at least one of a plurality of virtual objects in the 3-dimensional representation of the real-world scene.

4. The method as claimed in claim 1,
wherein the estimating of the coarse light map comprises:
receiving a plurality of incident rays from the real-world scene corresponding to the received plurality of images,
determining an intersection of the plurality of incident rays on the virtual sphere,
computing a plurality of reflected rays associated with the virtual sphere, when the plurality of incident rays is intersected on the virtual sphere,
analysing the computed plurality of reflected rays based on a neural radiance field (NeRF) model, and
estimating the coarse light map of the real-world scene on the virtual sphere, based on the analysed plurality of reflected rays, and
wherein the coarse light map indicates noisy projection of the real-world scene on the virtual sphere.

5. The method as claimed in claim 1, wherein the estimating of the enhanced virtual sphere comprises:
operating the at least one generated 2D image based on a ControlNet technique and the pre-trained diffusion model, by at least one of a prompt notification and an inpainting mask, and
estimating the enhanced virtual sphere, in 2D, based on the operation, wherein the enhanced virtual sphere indicates a hyper-realistic sphere mirror.

6. The method as claimed in claim 1, wherein the estimating of the light map comprises:
converting the enhanced virtual sphere from 2D to 3D enhanced virtual sphere,
determining an intersection of a plurality of incident rays, passing through each enhanced virtual sphere,
determining a surface normal for each of the plurality of images, based on the intersection,
computing a plurality of reflected rays associated with the enhanced virtual sphere, based on the determined surface normal, and
estimating the light map of the real-world scene based on light intensities corresponding to the computed plurality of reflected rays to re-light a plurality of virtual objects in an extended reality.

7. A system for estimating a light map of a real-world scene, the system comprising:
memory, comprising one or more storage media, storing instructions; and
at least one processor communicatively coupled to the memory,
wherein the instructions, when executed by the at least one processor individually or collectively, cause the system to:
receive a plurality of images corresponding to the real-world scene by a plurality of cameras,
generate a 3-dimensional (3D) representation of the real-world scene based on the received plurality of images,
position a virtual sphere within the generated 3D representation of the real-world scene,
estimate a coarse light map of the real-world scene on the virtual sphere,
generate at least one 2-dimensional (2D) image corresponding to the virtual sphere with the estimated coarse light map,
estimate an enhanced virtual sphere by operating the at least one generated 2D image based on a pre-trained diffusion model, and
estimate the light map of the real-world scene based on the enhanced virtual sphere.

8. The system as claimed in claim 7, wherein to generate the 3D representation of the real-world scene, the instructions, when executed by the at least one processor individually or collectively, further cause the system to:
process the received plurality of images based on a neural radiance field (NeRF) model; and
generate the 3D representation of the real-world scene based on the processed plurality of images.

9. The system as claimed in claim 7, wherein the virtual sphere is positioned at a location corresponding to a placement of at least one of a plurality of virtual objects in the 3-dimensional representation of the real-world scene.

10. The system as claimed in claim 7,
wherein to estimate the coarse light map, the instructions, when executed by the at least one processor individually or collectively, further cause the system to:
receive a plurality of incident rays from the real-world scene corresponding to the received plurality of images,
determine an intersection of the plurality of incident rays on the virtual sphere,
compute a plurality of reflected rays associated with the virtual sphere, when the plurality of incident rays s intersected on the virtual sphere,
analyse the computed plurality of reflected rays based on a neural radiance field (NeRF) model, and
estimate the coarse light map of the real-world scene on the virtual sphere, based on the analysed plurality of reflected rays, and
wherein the coarse light map indicates noisy projection of the real-world scene on the virtual sphere.

11. The system as claimed in claim 7,
wherein to estimate the enhanced virtual sphere, the instructions, when executed by the at least one processor individually or collectively, further cause the system to:
operate the at least one generated 2D image based on a ControlNet technique and the pre-trained diffusion model, by at least one of a prompt notification and an inpainting mask, and
estimate the enhanced virtual sphere, in 2D, based on the operation, and
wherein the enhanced virtual sphere indicates a hyper-realistic sphere mirror.

12. The system as claimed in claim 7, wherein to estimate the light map, the instructions that, when executed by the at least one processor individually or collectively, further cause the system to:
convert the enhanced virtual sphere from 2D to 3D enhanced virtual sphere;
determine an intersection of a plurality of incident rays, passing through each enhanced virtual sphere;
determine a surface normal for each of the plurality of images, based on the intersection;
compute a plurality of reflected rays associated with the enhanced virtual sphere, based on the determined surface normal; and
estimate the light map of the real-world scene based on light intensities corresponding to the computed plurality of reflected rays to re-light a plurality of virtual objects in an extended reality.

13. One or more non-transitory computer-readable storage media storing one or more computer programs including computer-executable instructions that, when executed by one or more processors of a system individually or collectively, cause the system to perform operations, the operations comprising:
receiving a plurality of images corresponding to the real-world scene by a plurality of cameras;
generating a 3-dimensional (3D) representation of the real-world scene based on the received plurality of images;
positioning a virtual sphere within the generated 3D representation of the real-world scene;
estimating a coarse light map of the real-world scene on the virtual sphere;
generating at least one 2-dimensional (2D) image corresponding to the virtual sphere with the estimated coarse light map;
estimating an enhanced virtual sphere by operating the at least one generated 2D image based on a pre-trained diffusion model; and
estimating the light map of the real-world scene based on the enhanced virtual sphere.

14. The one or more non-transitory computer-readable storage media of claim 13, wherein the generating of the 3D representation of the real-world scene comprises:
processing the received plurality of images based on a neural radiance field (NeRF) model, and
generating the 3D representation of the real-world scene based on the processed plurality of images.

15. The one or more non-transitory computer-readable storage media of claim 13, wherein the virtual sphere is positioned at a location corresponding to a placement of at least one of a plurality of virtual objects in the 3-dimensional representation of the real-world scene.

16. The one or more non-transitory computer-readable storage media of claim 13,
wherein the estimating of the coarse light map comprises:
receiving a plurality of incident rays from the real-world scene corresponding to the received plurality of images,
determining an intersection of the plurality of incident rays on the virtual sphere,
computing a plurality of reflected rays associated with the virtual sphere, when the plurality of incident rays is intersected on the virtual sphere,
analyzing the computed plurality of reflected rays based on a neural radiance field (NeRF) model, and
estimating the coarse light map of the real-world scene on the virtual sphere, based on the analyzed plurality of reflected rays, and
wherein the coarse light map indicates noisy projection of the real-world scene on the virtual sphere.

17. The one or more non-transitory computer-readable storage media of claim 13, wherein the estimating of the enhanced virtual sphere comprises:
operating the at least one generated 2D image based on a ControlNet technique and the pre-trained diffusion model, by at least one of a prompt notification and an inpainting mask, and
estimating the enhanced virtual sphere, in 2D, based on the operation, wherein the enhanced virtual sphere indicates a hyper-realistic sphere mirror.

18. The one or more non-transitory computer-readable storage media of claim 13, wherein the estimating of the light map comprises:
converting the enhanced virtual sphere from 2D to 3D enhanced virtual sphere,
determining an intersection of a plurality of incident rays, passing through each enhanced virtual sphere,
determining a surface normal for each of the plurality of images, based on the intersection,
computing a plurality of reflected rays associated with the enhanced virtual sphere, based on the determined surface normal, and
estimating the light map of the real-world scene based on light intensities corresponding to the computed plurality of reflected rays to re-light a plurality of virtual objects in an extended reality.

19. The one or more non-transitory computer-readable storage media of claim 16, wherein the NeRF model uses a neural network to predict a color and a density of a point in 3D space.

20. The one or more non-transitory computer-readable storage media of claim 19, wherein multiple points are sampled along each ray of each pixel of the plurality of images to project the real-world scene from a particular view using the NeRF model.
